(19) United States
(12) Patent Application Publication
(10) Pub. No.: US 2026/0155545 A1
(43) Pub. Date: Jun. 4, 2026

(54) SECONDARY BATTERY MODULE

(71) Applicant: TOYOTA JIDOSHA KABUSHIKI KAISHA, Toyota-shi (JP)

(72) Inventor: Shingo Komura, Nagakute-shi (JP)

(73) Assignee: TOYOTA JIDOSHA KABUSHIKI KAISHA, Toyota-shi (JP)

(21) Appl. No.: 19/273,699

(22) Filed: Jul. 18, 2025

(30) Foreign Application Priority Data
Nov. 30, 2024 (JP) 2024-209183

(51) Int. Cl. H01M 50/569; H01M 4/02; H01M 50/209

(52) U.S. Cl. CPC H01M 50/569; H01M 50/209; H01M 2004/029

(57) ABSTRACT

The present disclosure relates to a secondary battery, and more particularly, to a structure of a secondary battery module in which multiple cells are stacked. In the secondary battery module, at least two voltage detection terminals are provided for each of the current collector foils. As a result, even when one of the voltage detection terminals is damaged, a state in which detection of the voltage and the inflow and outflow of current for each cell such as discharge inactivation are enabled is maintained, and the balancing processing time can be shortened.

### CROSS-REFERENCE TO RELATED APPLICATION

This application claims priority to Japanese Patent Application No. 2024-209183 filed on Nov. 30, 2024. The disclosure of the above-identified application, including the specification, drawings, and claims, is incorporated by reference herein in its entirety.

### BACKGROUND

### 1. Technical Field

The present disclosure relates to a secondary battery, and more particularly, to a structure of a secondary battery module in which multiple cells are stacked.

### 2. Description of Related Art

A secondary battery such as a lithium-ion secondary battery includes, in short, a stacked structure in which a positive electrode active material layer coated on a current collector foil (positive electrode foil) that may be a metal foil and a negative electrode active material layer coated on a current collector foil (negative electrode foil) that may be a metal foil face each other with a separator interposed therebetween, and an electrolyte is injected between the current collector foils. Various configurations have been proposed to solve various problems that may occur in such a secondary battery. For example, in Japanese Unexamined Patent Application Publication No. 2020-4681 (JP 2020-4681 A), a battery module is proposed as a configuration capable of easily suppressing variations in path resistance of each of the multiple connection paths electrically connecting electrode terminals of multiple battery cells that are stacked and a voltage detection unit. The battery module includes multiple battery cells that are stacked and a voltage detection unit disposed on outer surfaces of the battery cells that are stacked and performing voltage detection of the battery cells by being electrically connected to the electrode terminals of the battery cells. A connection path between an electrode terminal of a part of the battery cells and the voltage detection unit is configured by a connection circuit having a certain pattern, and all of the electrode terminals of the battery cells are electrically connected to the voltage detection unit by using the connection circuit having the same pattern. In Japanese Unexamined Patent Application Publication No. 2020-64738 (JP 2020-64738 A), a battery module is proposed as a configuration for a battery module and a battery unit that makes it possible to improve a handling property of a detection line and facilitates assembly operations. The battery module includes a stacked cell assembly configured by stacking multiple cells, a top cover that covers terminals of the cells, and a voltage detection line that detects a voltage of each of the cells. The battery module has a configuration in which the top cover includes a position restriction unit for positioning the voltage detection line at a predetermined position.

Further, as one of configurations of the secondary battery, a battery module is known in which battery cells, for example, 30 cells, are stacked in series. Each of the battery cells has a stacked structure in which a positive electrode active material layer coated on a positive electrode foil and a negative electrode active material layer coated on a negative electrode foil face each other with a separator interposed therebetween and an electrolyte is injected between the positive electrode foil and the negative electrode foil. For example, Japanese Unexamined Patent Application Publication No. 2023-147142 (JP 2023-147142 A) may be referenced. In such a battery module, a positive electrode foil and a negative electrode foil are bonded to a negative electrode foil and a positive electrode foil of an adjacent cell having a stacked structure, respectively. As a result, except for both ends of the battery, the separator is interposed between two bipolar electrode bodies (an electrode body in which a negative electrode active material layer, a current collector foil, and a positive electrode active material layer are stacked in this order). In this configuration, the current collector foil has a dimension of slightly more than 1 m in both the vertical and horizontal directions, while the thickness of the current collector foil is, for example, about 30 μm to 40 μm. The thickness of a single cell is, for example, 1 mm to 2 mm. In such a battery module, as a voltage detection terminal for detecting a voltage of each cell, a terminal having a pin shape and a width of several mm is provided at the end of each current collector foil, and a configuration in which voltage detection terminals of the current collector foils are gathered is provided in a region near one corner of the module, for example.

### SUMMARY

In a battery module including multiple cells, in a case where electrical access to each current collector foil is possible only through a voltage detection terminal attached to each current collector foil, an electrical operation on each cell, for example, detection of a voltage of each cell and outflow and inflow of a current at each cell is performed through the voltage detection terminal of each current collector foil. For example, a “balancing” processing is periodically performed as a processing for equalizing variations in an amount of electric power stored in each cell, in order to equalize a load between the cells in the battery module and thereby extend battery life as long as possible. In the balancing processing, a cell having the lowest voltage is used as a reference, and a surplus amount of electric power is discharged from the remaining cells. The discharge of an amount of electric power from each cell is carried out through a voltage detection terminal of each current collector foil. For some reason, even in a “discharge inactivation” processing that forcibly discharges an amount of electric power stored in the battery module, the discharge of the amount of electric power from each cell is carried out through the voltage detection terminal of each current collector foil.

Therefore, in the battery module as described above, in a case where there is only one group of the voltage detection terminals of each of the cells, and for some reason, an abnormality occurs in the group of the voltage detection terminals, the voltage of each cell cannot be detected, the safety cannot be confirmed, and a situation in which inflow and outflow of a current for each cell, such as the “balancing” processing or the “discharge inactivation” processing, cannot be performed may occur. In particular, in a case where the thickness of each cell in the battery module is small and the contact area between the voltage detection terminal and the current collector foil is small, an abnormality such as disconnection in the voltage detection terminal may occur due to stress such as vibration and impact. In addition, in the battery module as described above, in a case where the contact area between the voltage detection terminal and the current collector foil is small, the magnitude of the allowable current inflow and outflow at the voltage detection terminal is relatively small, and thus the time needed for the “balancing” processing may increase.

In view of the above circumstances, an object of the present disclosure is to enable detection of the voltage and inflow and outflow of the current for each cell, and to increase an amount of allowable current inflow and outflow at each cell, even when there is an abnormality in one group of voltage detection terminals, in a battery module in which multiple cells are connected, the cells each having a stacked structure in which a positive electrode active material layer coated on a current collector foil of a positive electrode and a negative electrode active material layer coated on a current collector foil of a negative electrode face each other with a separator interposed therebetween and an electrolyte is injected between the current collector foils.

In a secondary battery module according to the present disclosure, multiple cells are connected, the cells each having a stacked structure in which a positive electrode active material layer coated on a current collector foil of a positive electrode and a negative electrode active material layer coated on a current collector foil of a negative electrode face each other with a separator interposed between the positive electrode active material layer and the negative electrode active material layer, and an electrolyte is injected between the current collector foils, and at least two voltage detection terminals are provided on each of the current collector foils.

In the above configuration, the cells that constitute the secondary battery module may be a non-aqueous secondary battery cell, and typically may be a lithium-ion secondary battery cell. The current collector foil (positive electrode foil) of the positive electrode and the current collector foil (negative electrode foil) of the negative electrode may be a current collector made of a metal foil in a normal aspect, and the positive electrode active material layer and the negative electrode active material layer may be coated on the positive electrode foil and the negative electrode foil, respectively, in a normal aspect. The separator and the electrolyte may also be a separator and an electrolyte in a normal aspect. The positive electrode foil and the negative electrode foil may have outer peripheral edges held by a sealing portion.

In the configuration of the above aspect of the present disclosure, at least two voltage detection terminals are provided on each of the current collector foils. With such a configuration, in the secondary battery module, there are at least two groups of the voltage detection terminals of each of the cells. Therefore, even when the abnormality occurs in one group of the voltage detection terminals due to some reason, it is possible to detect the voltage for each cell and perform the balancing processing or the discharge inactivation processing in the other group of the voltage detection terminals. In addition, in a case where there is no abnormality in the group of the voltage detection terminals, providing the at least two voltage detection terminals is advantageous in that the balancing processing can be completed more quickly since the amount of allowable current inflow and outflow temporarily increases due to an increase in the number of terminals through which the current for each cell is allowed to flow in and out.

In the configuration of the present disclosure, in each of the cells, the positive electrode active material layer coated on one current collector foil of the positive electrode and the negative electrode active material layer coated on one current collector foil of the negative electrode may face each other with the separator interposed between the positive electrode active material layer and the negative electrode active material layer.

In addition, the secondary battery module of the present disclosure may have a structure in which multiple bipolar electrode bodies are stacked with the separator interposed therebetween, the bipolar electrode bodies being constituted by bonding the current collector foil of the positive electrode and the current collector foil of the negative electrode of each of the cells to a current collector foil of a negative electrode and a current collector foil of a positive electrode of an adjacent cell, respectively. In this regard, the configuration according to the present disclosure is advantageously applied in a case where the thickness of each of the cells is small and the contact area between the voltage detection terminal and the current collector foil is small. In such a configuration, an abnormality such as disconnection is likely to occur due to stress such as vibration or impact between each voltage detection terminal and the current collector foil. Conversely, in the configuration of the present disclosure, at least two voltage detection terminals are provided on each of the current collector foils, and a possibility that the abnormality occurs in the voltage detection terminals at the same time is low. Therefore, a possibility that the detection of the voltage and the inflow and outflow of the current for each of the cells may not be performed is reduced as compared with a case where only one voltage detection terminal is provided on each of the current collector foils.

Further, in the configuration of the present disclosure, one and the other of the at least two voltage detection terminals in each of the cells may be provided on different edges of the secondary battery module. In a case where the secondary battery module is mounted on a vehicle, and the vehicle comes into contact with an obstacle and damage due to the contact occurs in the secondary battery module, the other voltage detection terminal is likely to be undamaged even though the one voltage detection terminal is damaged, as long as portions where the at least two voltage detection terminals are provided in each of the cells are different edges or opposite edges of the secondary battery module. As a result, the possibility that the detection of the voltage and the inflow and outflow of the current for each of the cells cannot be performed is further reduced. Further, in the configuration of the present disclosure, the one and the other of the at least two voltage detection terminals in each of the cells may be provided at portions spaced apart by ⅓ or more of a length of the short edge of the secondary battery module. According to such a configuration, as shown in the Experimental Example described below, the possibility that the detection of the voltage and the inflow and outflow of the current for each of the cells cannot be performed when the secondary battery module is vibrated is reduced.

As a result, according to the configuration of the present disclosure, in the secondary battery module in which multiple cells are connected, the cells each having a stacked structure in which a positive electrode active material layer coated on a current collector foil of a positive electrode and a negative electrode active material layer coated on a current collector foil of a negative electrode face each other with a separator interposed between the positive electrode active material layer and the negative electrode active material layer, and an electrolyte is injected between the current collector foils, at least two voltage detection terminals are provided on each of the current collector foils. From this, even when an abnormality occurs in one of the voltage detection terminals, a state in which the detection of the voltage and the inflow and outflow of current for each of the cells can be performed is maintained. Further, the amount of allowable current inflow and outflow at each current collector foil can be increased due to an increase in the number of the voltage detection terminals, and the time needed for the balancing processing can be shortened.

Other objects and advantages of the present disclosure will be made apparent from the following description of a preferred embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic perspective view of a secondary battery module to which the present embodiment is applied;

FIG. 1B is a schematic plan view of the secondary battery module to which the present embodiment is applied;

FIG. 2A is a schematic cross-sectional view of one bipolar electrode body in the secondary battery module to which the present embodiment is applied;

FIG. 2B is a schematic plan view of a current collector foil of each of the cells of the secondary battery module to which the present embodiment is applied; and

FIG. 2C is a schematic cross-sectional view of a state in which bipolar electrode bodies of the secondary battery module to which the present embodiment is applied are stacked.

### DETAILED DESCRIPTION OF EMBODIMENTS

The present disclosure will be described in detail with reference to the accompanying drawings in the following, in several preferred embodiments. In the drawings, the same reference numerals denote the same parts.

### Configuration of Secondary Battery Module

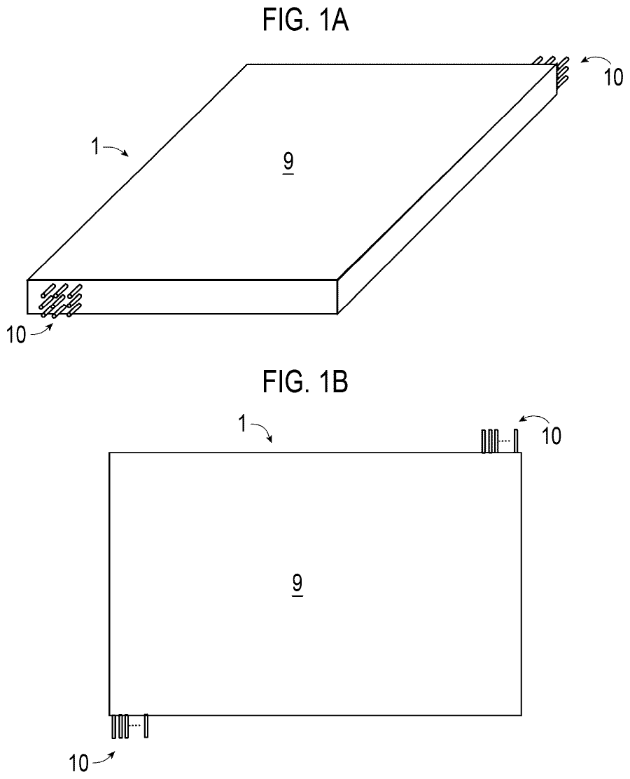

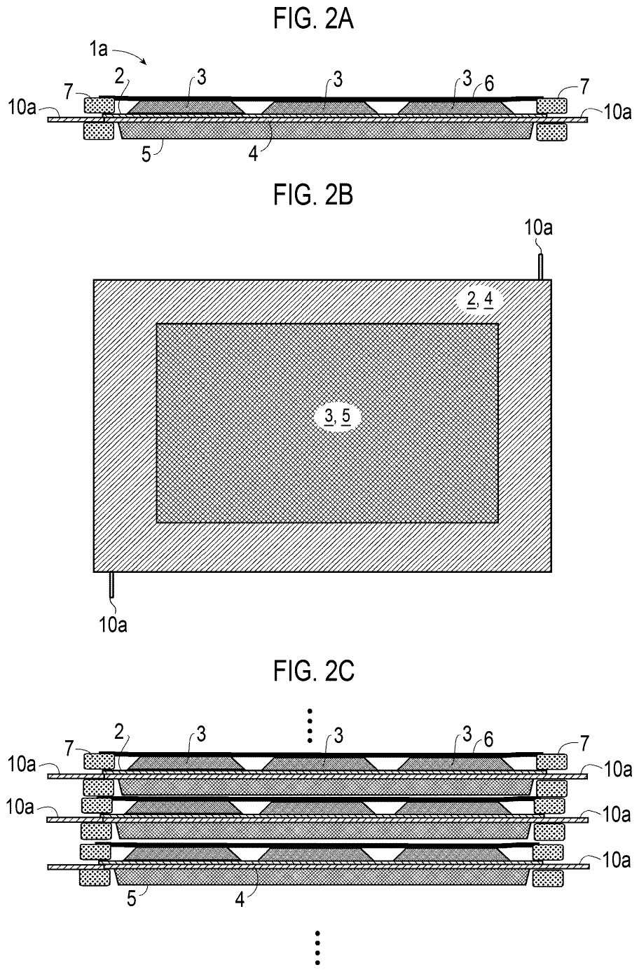

As illustrated in FIG. 1A and FIG. 1B, a secondary battery module 1 to which the present embodiment is applied may have a substantially rectangular flat plate structure as a whole. In the secondary battery module 1, the bipolar electrode body 1a as shown in FIG. 2A is stacked with the separator 6 interposed therebetween as shown in FIG. 2C, the periphery thereof is fixed by the sealing portion 7, and an electrolyte is injected through an unillustrated injection port into each space between the electrode bodies, thereby forming a state in which a plurality of flat secondary battery cells are stacked. In each of bipolar electrode bodies 1a, as shown in FIG. 2A, a current collector foil 2 on a positive electrode side and a current collector foil 4 on a negative electrode side may be bonded to each other, and as shown in FIG. 2B, a positive electrode active material 3 and a negative electrode active material 5 may be coated on the central region of each of the current collector foils 2, 4, and the peripheral edges of the current collector foils 2, 4 may be held by the sealing portion 7 (an electrode body in which solely the positive electrode or solely the negative electrode is provided is stacked on both outermost layers of the secondary battery module 1). In the secondary battery module 1 shown in the drawing, the vertical and horizontal dimensions are, respectively, slightly more than 1 m, the thickness of each of the cells is 1 to 2 mm, and the thickness of the current collector foil is 30 to 40 μm. Any material or substance used in the field may be used for the current collector foils 2, 4, the positive electrode and negative electrode active materials 3, 5, the separator 6, the sealing portion 7, and the electrolyte. In addition, according to the above configuration, in the secondary battery module 1, each cell is electrically connected in series. Typically, 30 cells may be connected in series in one secondary battery module 1, but the present disclosure is not limited thereto.

In the secondary battery module 1 as described above, since the cells are connected in series, the current at the time of charging and discharging flows in and out from the positive electrode foil and the negative electrode foil of both outermost layers of the secondary battery module 1. On the other hand, the voltage detection of each cell, the balancing processing for performing the outflow and inflow of the individual currents of each cell, and the discharge inactivation processing cannot be performed from the positive electrode foil and the negative electrode foil of the outermost layer of the secondary battery module 1. Therefore, as schematically shown in FIGS. 2A to 2C, an electrically individually accessible terminal 10a is attached to the current collector foil of each cell as a voltage detection terminal that makes it possible to detect the voltage of each cell and to flow in and out the individual current of each cell. Each of the voltage detection terminals 10a may typically have a pin shape having a width of several mm that protrudes outward through the sealing portion 7. In the bipolar electrode body 1a, the positive electrode foil 2 and the negative electrode foil 4 are bonded to each other and are substantially at the same potential, so that the voltage detection terminal may be common. In the secondary battery module 1, the voltage detection terminals 10a of the cells may be provided to be assembled in a relatively small region of the periphery of the secondary battery module 1 as shown by the reference numeral 10 in FIGS. 1A and 1B.

In a case where the voltage detection terminals are provided solely one by one for each current collector foil, when an abnormality occurs in one voltage detection terminal and the conduction between the voltage detection terminal and the current collector foil is lost, the voltage of the cell constituting the current collector foil cannot be detected, and the current flowing in and out of each cell, such as the balancing processing and the discharge inactivation processing, cannot be performed. In particular, in the secondary battery module 1 as shown in the drawing, the dimensions of the voltage detection terminals are very small with respect to the vertical and horizontal dimensions of the cells, and the contact area between the voltage detection terminals and the current collector foils is also small. Therefore, there is a possibility that the voltage detection terminals and the current collector foils are disconnected due to vibration or impact. In addition, in one pin-shaped voltage detection terminal, the amount of permissible current flow is relatively small, so that the balancing processing time may be long.

Therefore, in the present embodiment, as shown in FIGS. 1A, 1B, and 2A, to 2C, at least two voltage detection terminals are provided in each current collector foil. In this case, in the secondary battery module 1, at least two portions where the voltage detection terminals 10a of the cells are gathered may be provided (at least two voltage detection terminals provided on each current collector foil are disposed at separate portions). According to such a configuration, in each current collector foil, even when one voltage detection terminal 10a is not in a state of electrical conduction, the state in which the detection of the voltage for each cell and the inflow and outflow of current are enabled is maintained as long as the other voltage detection terminals 10a are in a state of electrical conduction. In a case where two or more voltage detection terminals 10a are provided in each current collector foil, the amount of permissible current inflow and outflow of each cell at once through the voltage detection terminals 10a is larger than in a case where the voltage detection terminals 10a are provided in one, and thus it is possible to shorten the time of the balancing processing.

In the configuration in which at least two voltage detection terminals 10a are provided in each of the current collector foils, the degree to which the state in which the detection of the voltage of each cell and the inflow and outflow of the current of each cell, such as the discharge inactivation processing, and the balancing processing, can be maintained is different depending on the portion where the voltage detection terminal 10a is provided, according to the Experimental Example described below. In short, in each current collector foil, when at least two voltage detection terminals 10a are provided on different edges or the provided positions are spaced apart from each other, the ability to maintain the state in which the voltage of each cell can be detected, and the discharge inactivation processing and the balancing processing can be performed is increased. Therefore, preferably, at least two voltage detection terminals 10a may be provided at different edges or opposite edges of each current collector foil, or at positions as far apart as possible or opposite positions. According to the experiment, when one and the other of at least two voltage detection terminals in each cell are provided at a portion spaced apart by ⅓ or more of the short edge of the secondary battery module, the ability to maintain the state in which the voltage of each cell can be detected, and the discharge inactivation processing and the balancing processing can be performed is significantly increased.

### Experimental Example

The effectiveness of the present embodiment has been confirmed by the following Experimental Examples. It should be understood that the following Experimental Examples are examples for verifying the effectiveness of the embodiment and do not limit the range of the disclosure.

### (1) Verification of Balancing Processing Time

It was confirmed by the following experiment that when at least two voltage detection terminals are provided in each current collector foil in the secondary battery module, the balancing processing time is shortened. In the experiment, the following samples were prepared.

Comparative Example 1—As an electrode body, a bipolar electrode body including a lithium iron phosphate (LFP) positive electrode and a graphite negative electrode was prepared, and one voltage detection terminal was attached to an uncoated portion of a current collector foil for each cell by spot welding. Thereafter, a plurality of electrode bodies, separators, and sealing materials in a state of being superimposed were stacked to form a module, and a polyethylene (PE) block was end surface-welded to the frame portion thereof to reinforce the moisture barrier effect. Then, the side surfaces of the module were covered with an aluminum (Al) laminate packaging material that has a cup shape, the space between the module and the Al laminate packaging material was sealed under reduced pressure, a moisture barrier function requested in the vehicle life was imparted, and the activation processing was performed to complete the module.
Embodiment 1—The same procedure as in Comparative Example 1 was performed, except that, for each cell, two voltage detection terminals were spot-welded to the uncoated portion of the current collector foil. In the module, the two voltage detection terminals are attached to different edges.
Embodiment 2—The same procedure as in Comparative Example 1 was performed, except that three voltage detection terminals were spot-welded to the uncoated portion of the current collector foil for each cell. In the module, the three voltage detection terminals are attached to different edges, respectively.

In the verification, a pseudo difference of 4% in SOC was given between the cells in the module prepared as described above, and a constant current discharge was performed from the voltage detection terminals at the maximum current within a specified current range, and the time until all the cells reached a uniform voltage was measured. The result was as follows.
Comparative Example 1:10.0 Hours;
Embodiment 1:5.0 hours;
Embodiment 2:3 3 hours
   In the above results, in Embodiments 1 and 2, the balancing processing time was significantly shorter than in Comparative Example 1. From this, it has been shown that the balancing processing time can be shortened by attaching at least two voltage detection terminals to each current collector foil.
   (2) Verification of Resistance of Voltage Detection Terminal to Function Retention against Vibration

The following experiment confirmed that the resistance of the voltage detection terminal to the function retention against vibration is increased when at least two voltage detection terminals are provided in each current collector foil in the secondary battery module. In the experiment, the same sample as in (1) was prepared.

In the verification, first, in Comparative Example 1, either or both of the T3 (vibration test) and T4 (impact test) of the UN transport regulation UN38.3 were repeated more than a predetermined number of times until voltage detection became impossible. Here, in the T3 (vibration test), logarithmic sweeping that changes the frequency of the sine waveform from 7 Hz to 200 Hz and from 200 Hz to 7 Hz is repeated 12 times in each of three directions for 15 minutes (that is, the test time is 9 hours in total). In the T4 (impact test), an impact of a sinusoidal half wave having a peak acceleration of 50 gn and a pulse duration of 11 ms was applied in three directions, a total of 18 times. Embodiments 1 and 2 were subjected to the same vibration and impact under the same conditions as those of Comparative Example 1.

Thereafter, the discharge inactivation was performed by either the method of discharging from the total +terminal/total-terminal of the module or the method of discharging each cell from the voltage detection terminal. In the case where the battery energy is less than 5% at full charge, the state is set to “possible”, and in the case where the battery energy is not less than 5% at full charge, the state is set to “impossible”. The result was as follows.
Comparative Example 1: Impossible;
Embodiment 1: Possible;
Embodiment 2: Possible
   From the above results, it has been shown that when at least two voltage detection terminals are attached to each current collector foil, the function of the voltage detection terminals to cause the current to flow in and out of each cell is maintained even when the vibration and the impact are applied to the extent that the voltage cannot be detected in one case.
   (3) Verification of Difference in Resistance of Voltage Detection Terminals to Function Retention against Vibration Depending on Attachment Portions of Voltage Detection Terminals

In the secondary battery module, a change in the resistance of the voltage detection terminal to the function retention against vibration depending on the portions of the two voltage detection terminals attached to each current collector foil was confirmed in the following experiment. In the experiment, the following samples were prepared.

Comparative Example 2—The same procedure as in Comparative Example 1 was performed, except that, for each cell, two voltage detection terminals were spot-welded to the same edge of the uncoated portion of the current collector foil at a distance of 1/20 of the length of the short side of the module.
Comparative Example 3—The same procedure as in Comparative Example 1 was performed, except that, for each cell, two voltage detection terminals were spot-welded to the same edge of the uncoated portion of the current collector foil at a distance of ⅕ of the length of the short side of the module.
Embodiment 3—The same procedures as in Comparative Example 1 were performed, except that, for each cell, two voltage detection terminals were spot-welded to the same edge of the uncoated portion of the current collector foil at a distance of ⅓ of the length of the short side of the module.
Embodiment 4—The same procedures as in Comparative Example 1 were performed, except that, for each cell, two voltage detection terminals were spot-welded to the same edge of the uncoated portion of the current collector foil at a distance equal to the length of the short side of the module.
Embodiment 5—The same procedures as in Comparative Example 1 were performed, except that, for each cell, two voltage detection terminals were spot-welded to different edges of the uncoated portion of the current collector foil such that the straight-line distance between the voltage detection terminals was equal to the length of the long side of the module.
Embodiment 6—The same procedures as in Comparative Example 1 were performed, except that, for each cell, two voltage detection terminals were spot-welded to different edges of the uncoated portion of the current collector foil such that the straight-line distance between the voltage detection terminals was equal to ½ the length of the long side of the module.

In the verification, first, in Comparative Example 2, either or both of the T3 (vibration test) and T4 (impact test) were repeated more than a predetermined number of times until the voltage detection became impossible. The same vibration and impact as in Comparative Example 2 were applied to Comparative Example 3 and Embodiments 3 to 6. Thereafter, the discharge inactivation was performed by either the method of discharging from the total+terminal/total−terminal of the module or the method of discharging each cell from the voltage detection terminal, in the same manner as in (2). In the case where the battery energy is less than 5% at full charge, the state is set to “possible”, and in the case where the battery energy is not less than 5% at full charge, the state is set to “impossible”. The result was as follows.
Comparative Example 2: Impossible;
Comparative Example 3: Impossible
Embodiment 3: Possible;
Embodiment 4: Possible;
Embodiment 5: Possible;
Embodiment 6: Possible
   With reference to the above results, in Embodiment 3 (an example in which two voltage detection terminals were provided for each cell at the same edge at a distance equal to ⅓ of the length of the short side of the module), discharge inactivation was achieved. From this, it has been shown that in a case where one and the other of at least two voltage detection terminals in each cell are provided at a portion spaced apart by ⅓ or more of the short edge of the secondary battery module, the resistance of the voltage detection terminal to the function retention against the vibration is significantly increased. In addition, from Embodiments 5 and 6, when one of at least two voltage detection terminals in each cell and the other are disposed on different edges, the resistance of the voltage detection terminal to the function retention against the vibration is significantly increased.

Accordingly, according to the present embodiment, at least two voltage detection terminals are provided in each current collector foil in the secondary battery module. As a result, even when one of the voltage detection terminals is damaged, the state in which the detection of the voltage for each cell and the inflow and outflow of current, such as discharge inactivation, are enabled, is maintained, and the balancing processing time can be shortened.

The above description relates to the embodiment of the disclosure, but various modifications and changes can be easily made by those skilled in the art. The disclosure is not limited to only the above exemplary embodiment, and it is obvious that the disclosure is applicable to various devices within a range not departing from the concepts of the disclosure.

What is claimed is:

1. A secondary battery module wherein:
multiple cells are connected, the cells each having a stacked structure in which a positive electrode active material layer coated on a current collector foil of a positive electrode and a negative electrode active material layer coated on a current collector foil of a negative electrode face each other with a separator interposed between the positive electrode active material layer and the negative electrode active material layer, and an electrolyte is injected between the current collector foils; and
at least two voltage detection terminals are provided on each of the current collector foils.

2. The secondary battery module according to claim 1, wherein, in each of the cells, the positive electrode active material layer coated on one current collector foil of the positive electrode and the negative electrode active material layer coated on one current collector foil of the negative electrode face each other with the separator interposed between the positive electrode active material layer and the negative electrode active material layer.

3. The secondary battery module according to claim 1, wherein the current collector foil of the positive electrode and the current collector foil of the negative electrode of each of the cells are bonded to a current collector foil of a negative electrode and a current collector foil of a positive electrode of an adjacent cell, respectively, to constitute a bipolar electrode body.

4. The secondary battery module according to claim 1, wherein one and the other of the at least two voltage detection terminals in each of the cells are provided on different edges of the secondary battery module.

5. The secondary battery module according to claim 1, wherein one and the other of the at least two voltage detection terminals in each of the cells are provided at portions spaced apart by ⅓ or more of a length of a short edge of the secondary battery module.
